(19) United States
(12) Patent Application Publication
(10) Pub. No.: US 2013/0066549 A1
(43) Pub. Date: Mar. 14, 2013

(54) NAVIGATION DEVICE AND METHOD

(71) Applicants: SHIH-PIN WU, Tu-Cheng (TW); HSING-CHU WU, Tu-Cheng (TW)

(72) Inventors: SHIH-PIN WU, Tu-Cheng (TW); HSING-CHU WU, Tu-Cheng (TW)

(73) Assignee: HON HAI PRECISION INDUSTRY CO., LTD., Tu-Cheng (TW)

(21) Appl. No.: 13/277,233

(22) Filed: Oct. 20, 2011

(30) Foreign Application Priority Data
Sep. 14, 2011 (TW) 100132939

(51) Int. Cl. G01C 21/36

(52) U.S. Cl. 701/425

(57) ABSTRACT

An exemplary navigation device includes an input unit, a storage unit, a GPS detector, a driving recorder, a gyroscope, and a processor. The input unit is to receive user input. The storage unit stores map database comprising road maps. The positioning detector is to detect the geographical position of a vehicle. The driving recorder is to capture video. The gyroscope is to detect the turn angle of the vehicle. Firstly, the processor determines a driving route. Then, obtains the geographical position of the vehicle, obtains video, obtains road map, obtains turn angle of the vehicle, and determine the lane that the vehicle is in according to the captured video. Next, generates indications according to the determined driving route, the road map, the lane that the vehicle is in, the turn angle of the vehicle, and the geographical position of the vehicle.

### BACKGROUND

1. Technical Field

The present disclosure relates to navigation devices and navigation methods and, particularly, to a navigation device capable of prompting a driver driving in a dark condition and a navigation method for the navigation device.

2. Description of Related Art

Navigation devices are widely used in motor vehicles to help guide a driver. However, when a driver drives the vehicle in dark conditions, the driver can not see far ahead. In that situation, on an upcoming turn, the conventional navigation devices can only prompt the driver to turn right or turn left, but cannot prompt whether the vehicle is in a turn lane for the upcoming turn. This may leave the driver without enough time to change lane to drive in the turn lane to make the turn properly. Furthermore, if the vehicle is at a fork, the conventional navigation cannot prompt the driver the turn angle to be turned. Therefore, it is desired to be a navigation device to overcome the above shortcoming.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a navigation device in accordance with an exemplary embodiment.

FIG. 2 is a flowchart of a navigation method in accordance with an exemplary embodiment.

### DETAILED DESCRIPTION

Embodiments of the present disclosure are now described in detail, with reference to the accompanying drawings.

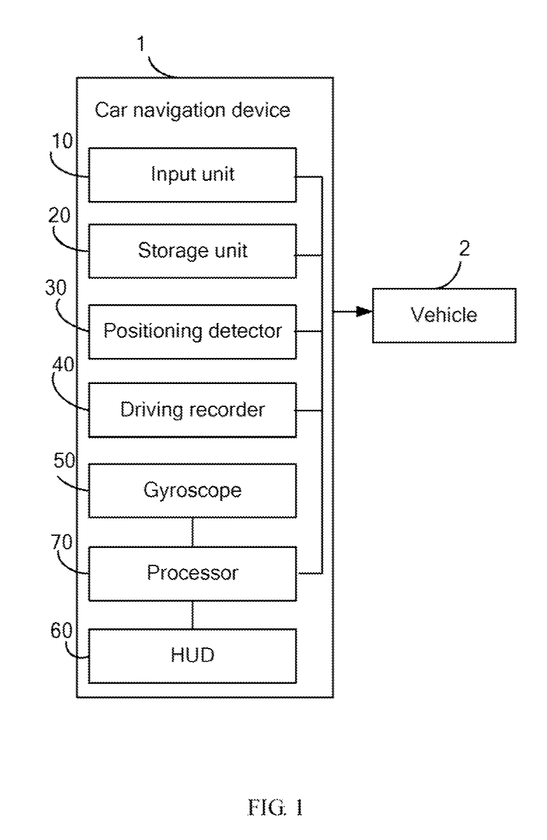

Referring to FIG. 1, a block diagram of a navigation device 1 in accordance with an exemplary embodiment is shown. The navigation device 1 includes an input unit 10, a storage unit 20, a positioning detector 30, such as a GPS detector 30, a driving recorder 40, a gyroscope 50, a Head-Up Display (HUD) 60, and a processor 70.

The input unit 10 is for receiving user input, such as a destination. The storage unit 20 at least stores map database which may include road map data for various areas. The positioning detector 30 is for detecting the geographical position of a vehicle 2 based on satellite signals. In the embodiment, the positioning detector 30 is a GPS detector. The driving recorder 40 is installed on the vehicle to capture video of the scene around the vehicle 2. The driving recorder 40 can further store the captured video to the storage unit 20. In the embodiment, the driving recorder 40 can capture video in a dark condition. The gyroscope 50 is to detect the turn angle of the vehicle 2. The HUD 60 is to project image to the windshield of the vehicle 2. In the embodiment, the HUD 60 projects information to the windshield of the vehicle 2 parallel with the eyes of the driver. The vehicle navigation device 1 is to control the HUD 60 to project information to the windshield according to the input destination, the road map, the geographic information from positioning detector 30, the video captured by the driving recorder 40, and the turn angle detected by the gyroscope 50.

The processor 70 is for determining a driving route according to the destination input from the input unit 10, the geography position of the vehicle, and the road map, and determine whether the vehicle 2 encounters a turn. In the embodiment, the processor 70 determines whether the vehicle 2 encounters a turn according to the detected turn angle of the gyroscope 50. If the detected turn angle of the gyroscope 50 is less than a predetermined value, such as 1 degree, the processor 70 determines that the vehicle 2 does not encounter a turn. If the detected turn angle of the gyroscope 50 is greater than a predetermined value, the processor 70 determines that the vehicle 2 encounters a turn. In another embodiment, the processor 70 determines whether the vehicle 2 is on straight or curved road in order to determine whether the vehicle 2 encounters a turn. In detail, the processor 70 determines which road the vehicle 2 is on according to the geographical position of the vehicle 2 detected by the GPS detector 30 and the road map in the storage unit 20. The processor 70 further determines whether the vehicle 2 encounters a turn. When the road is straight, the processor 70 determines that the vehicle 2 does not encounter a turn. When the road is curved, the processor 70 determines that the vehicle 2 encounters a turn.

When the vehicle 2 does not encounter a turn, the processor 70 obtains the video recorded by the driving recorder 40 from the storage unit 20, and determines a lane that the vehicle 2 is in according to the video. In the embodiment, the video records the lane separator, the street trees, another vehicle, and so on. For example, in the video, when the street trees are on the left, a vehicle and the lane separator are on the right, and the lane separator is on the right of the vehicle, the processor 70 determines that the vehicle 2 is in the left lane. The processor 70 further determines a next turn to determine a turn lane according to the detected geographical position of the vehicle 2 and a driving route of the vehicle 2. If the vehicle 2 is determined to be not in the turn lane, the processor 70 further determines the distance between the vehicle 2 and the turn according to the road map and the geography position of the vehicle 2. When the distance between the vehicle 2 and the turn is in a predetermined range, the processor 70 controls the HUD 60 to project an indication to the windshield to prompt the driver to drive the vehicle 2 to the turn lane, thus the driver can drive his vehicle 2 without taking his eyes from the windshield, it will reduce accident. In another embodiment, the processor 70 further controls the HUD 60 to project the area of the road map where the vehicle 2 is to the windshield. In the embodiment, the indication is a line with an arrowhead. In another embodiment, the indication further includes some words to prompt the driver to drive the vehicle 2 into a turn lane. The processor 70 further controls the HUD 60 to stop projecting the indication to the windshield when the vehicle 2 is determined to be in a turn lane.

When the vehicle 2 encounters a turn, the processor 70 determines a turn angle of the turn according to the driving route and the geographical position of the vehicle 2. The processor 70 further obtains the turn angle that the vehicle 2 has turned in real time according to the gyroscope 50, and subtracts the turn angle that the vehicle 2 has turned from the turn angle of the turn to determine a further turn angle to be turned in real time. The processor 70 also controls the HUD 60 to project the indication to the windshield to prompt the driver to turn in real time according to the determined further turn angle to be turned, thus the vehicle 2 can be prevented from entering into a wrong turn when the vehicle 2 is in a fork. In the embodiment, when the turn angle that the vehicle 2 has turned is equal to the determined turn angle of the turn, the indication is a straight line with an arrowhead. When the turn angle that the vehicle 2 has turned is less than the determined turn angle of the turn, the indication is an arc line with an arrowhead. In another embodiment, the indication further includes some words to represent the further turn angle to be needed. The processor 70 further controls the HUD 60 to stop projecting the indication to the windshield when the vehicle 2 has driven from the turn. In another embodiment, the processor 70 further controls the HUD 60 to project the area of the road map where the vehicle 2 is to the windshield.

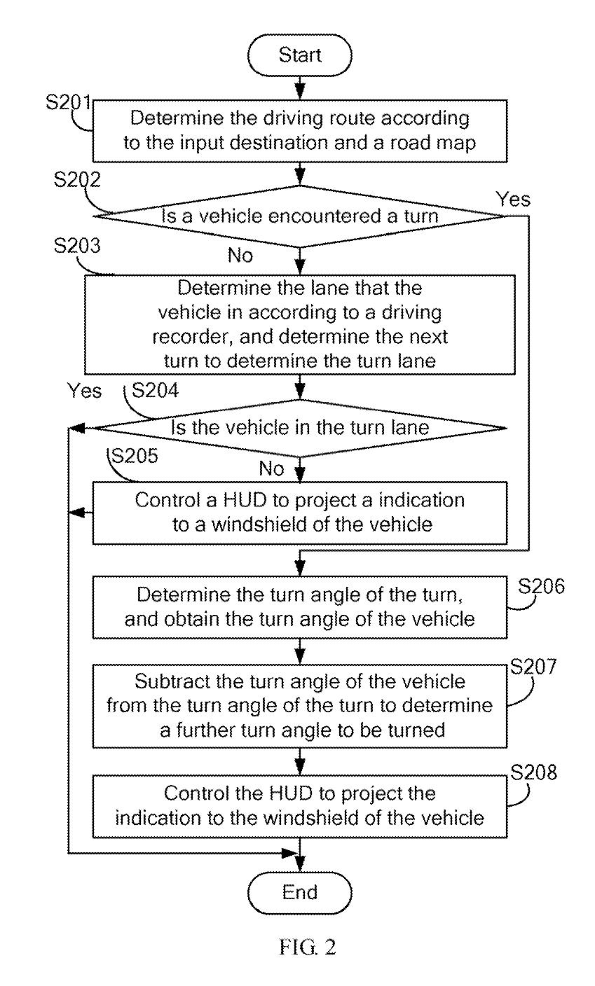

Referring to FIG. 2, a flowchart of a navigation method is employed on the navigation device 1 of FIG. 1 is shown.

In step S201, the processor 70 determines a driving route according to the destination input from the input unit, the geography position of the vehicle, and the road map.

In step S202, the processor 70 determines whether the vehicle 2 encounters a turn. When the vehicle 2 does not encounter a turn, the procedure goes to step S203. When the vehicle 2 encounters a turn, the procedure goes to step S207.

In step S203, the processor 70 determines the lane that the vehicle 2 is in according to the video captured by the driving recorder 40, and determines the next turn to determine a turn lane according to the determined lane of the vehicle 2 and the geographical position of the vehicle 2.

In step S204, the processor 70 determines whether the vehicle 2 is in the turn lane. When the vehicle 2 is not in the turn lane, the procedure goes to step S205. When the vehicle 2 is in the turn lane, the procedure goes to end.

In step S205, the processor 70 controls the HUD 60 to project the indication to the windshield to prompt the driver to drive the vehicle 2 to the turn lane when determining that the distance between the vehicle 2 and the turn is in a predetermined range.

In step S206, the processor 70 determines the turn angle of the turn according to the determined driving route and the determined geographical position of the vehicle 2, and obtains the turn angle of the vehicle 2 in real time from the gyroscope 50.

In step S207, the processor 70 subtracts the turn angle of the vehicle 2 from the turn angle of the turn to determine a further turn angle to be turned in real time.

In step S208, the processor 70 controls the HUD 60 to project indication to the windshield in real time to prevent the driver from driving the vehicle into a wrong turn.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A navigation device comprising:
an input unit to receive user input;
a storage unit storing map database comprising road maps;
a positioning detector to detect the geographical position of a vehicle based on satellite signals;
a driving recorder to capture video;
a gyroscope to detect turn angle of the vehicle; and
a processor to determine a driving route according to the destination input from the input unit, obtain the geographical position of the vehicle from the positioning detector, obtain video from the driving recorder, obtain a road map from the storage unit according to the destination, obtain a turn angle of the vehicle from the gyroscope, determine the lane that the vehicle is in according to the captured video, and further generate indications for a driver according to the determined driving route, the road map, the lane that the vehicle is in, the turn angle of the vehicle, and the geographical position of the vehicle.

2. The navigation device as described in claim 1, wherein when the turn angle of the vehicle detected by the gyroscope is less than a predetermined value, the processor determines that the vehicle does not encounter a turn, when the turn angle of the vehicle detected by the gyroscope is more than the predetermined value, the processor determines that the vehicle encounters a turn.

3. The navigation device as described in claim 1, wherein the processor determines which road the vehicle is on according to the geographical position of the vehicle and the road map, determines whether the road is straight or curved, determines that the vehicle does not encounter a turn when the road is determined straight, and further determines that the vehicle encounters a turn when the road is determined curved.

4. The navigation device as described in claim 2, wherein the processor determines the lane that the vehicle is in according to the captured video when the vehicle does not encounter a turn, determines the next turn to determine a turn lane according to the determined driving route and the geographical position of the vehicle, determines whether the vehicle is in the turn lane, and further generates indication to prompt the driver to drive the vehicle to the turn lane when the vehicle is not in the turn lane.

5. The navigation device as described in claim 2, wherein the processor determines the turn angle of the turn when the vehicle encounters a turn according to the determined driving route and the geographical position of the vehicle, obtains the turn angle of the vehicle from the gyroscope in real time, subtracts the turn angle of the vehicle from the turn angle of the turn to determine the turn angle to be turned in real time, and further generates indication to prompt the drive to drive the vehicle in a turn angle to be turned in real time.

6. The navigation device as described in claim 3, wherein the processor determines the lane that the vehicle is in according to the captured video when the vehicle does not encounter a turn, determines the next turn to determine a turn lane according to the determined driving route and the geographical position of the vehicle, determines whether the vehicle is in the turn lane, and further provides indication to prompt the driver to drive the vehicle to the turn lane when the vehicle is not in the turn lane.

7. The navigation device as described in claim 3, wherein the processor determines the turn angle of the turn when the vehicle encounters a turn according to the determined driving route and the geographical position of the vehicle, obtains the turn angle of the vehicle from the gyroscope in real time, subtracts the turn angle of the vehicle from the turn angle of the turn to determine a further turn angle to be turned in real time, and further provides indication to prompt the drive to drive the vehicle in a turn angle to be turned in real time.

8. The navigation device as described in claim 1, wherein the navigation device further comprises a head-up display (HUD) to project image to the windshield, the processor further controls HUD to project the indications to the windshield of the vehicle.

9. A navigation method employed by a navigation device, the navigation device comprising an input unit, a storage unit, a positioning detector, a driving recorder, and a gyroscope, the input unit being to receive user input, the storage unit storing map database comprising road maps, the positioning detector being to detect the geographical position of a vehicle based on satellite signals, the driving recorder being to capture video, and the gyroscope being to detect the turn angle of the vehicle, the method comprising:
determining a driving route according to the destination input from the input unit;
obtaining the geographical position of the vehicle from the positioning detector, obtaining video from the driving recorder, obtaining road map from the storage unit, and obtaining turn angle of the vehicle from the gyroscope;
determining the lane that the vehicle is in according to the captured video; and
generating indications for a driver according to the determined driving route, the road map, the determined lane that the vehicle is in, the turn angle of the vehicle, and the geographical position of the vehicle.

10. The navigation method as described in claim 9, wherein the method further comprises:
determining that the vehicle does not encounter a turn when the turn angle of the vehicle detected by the gyroscope is less than a predetermined value; and
determining that the vehicle encounters a turn when the turn angle of the vehicle detected by the gyroscope is more than the predetermined value.

11. The navigation method as described in claim 9, wherein the method further comprises:
determining which road the vehicle is on according to the geographical position of the vehicle and the road map;
determining whether the vehicle is on straight or curved road;
determining that the vehicle does not encounter a turn when the road is determined straight; and
determining that the vehicle encounters a turn when the road is determined curved.

12. The navigation method as described in claim 10, wherein the method further comprises:
determining the lane that the vehicle is in according to the captured video when the vehicle does not encounter a turn;
determining the next turn to determine a turn lane according to the determined driving route and the geographical position of the vehicle;
determining whether the vehicle is in the turn lane; and
generating indication to prompt the driver to drive the vehicle to the turn lane when the vehicle is not in the turn lane.

13. The navigation method as described in claim 10, wherein the method further comprises:
determining the turn angle of the turn when the vehicle encounters a turn according to the determined driving route and the geographical position of the vehicle;
obtaining the turn angle of the vehicle from the gyroscope in real time;
subtracting the turn angle of the vehicle from the turn angle of the turn to determine a further turn angle to be turned in real time; and
generating indication to prompt the drive to drive the vehicle in the further turn angle to be turned in real time.

14. The navigation method as described in claim 11, wherein the method further comprises:
determining the lane that the vehicle is in according to the captured video when the vehicle does not encounter a turn;
determining the next turn to determine a turn lane according to the determined driving route and the geographical position of the vehicle;
determining whether the vehicle is in the turn lane; and
generating indication to prompt the driver to drive the vehicle to the turn lane when the vehicle is not in the turn lane.

15. The navigation method as described in claim 11, wherein the method further comprises:
determining a turn angle of the turn when the vehicle encounters a turn according to the determined driving route and the geographical position of the vehicle;
obtaining the turn angle of the vehicle from the gyroscope in real time;
subtracting the turn angle of the vehicle from the turn angle of the turn to determine a further turn angle to be turned in real time; and
generating indication to prompt the drive to drive the vehicle in the further turn angle to be turned in real time.

16. The navigation method as described in claim 9, the navigation device further comprises a head-up display (HUD) to project image to the windshield, wherein the method further comprises:
controlling HUD to project the indications to the windshield of the vehicle.
